(19) United States
(12) Patent Application Publication
(10) Pub. No.: US 2015/0058417 A1
(43) Pub. Date: Feb. 26, 2015

(54) SYSTEMS AND METHODS OF PRESENTING PERSONALIZED PERSONAS IN ONLINE SOCIAL NETWORKS

(71) Applicant: salesforce.com, inc., San Francisco, CA (US)

(72) Inventors: Jager McConnell, San Francisco, CA (US); Ciara Peter, San Francisco, CA (US)

(21) Appl. No.: 14/143,450

(22) Filed: Dec. 30, 2013

Related U.S. Application Data
(60) Provisional application No. 61/868,020, filed on Aug. 20, 2013.

(51) Int. Cl. H04L 29/08

(52) U.S. Cl. CPC H04L 67/306
USPC 709/204

(57) ABSTRACT

The technology disclosed relates to providing personalized experience to viewers of online social profiles. In particular, it relates to creating person-specific personas of a user's online social profiles to be viewed by respective persons in the user's online social networks based on shared interests. The person-specific personas prominently display content selected from a user's profile that is determined to be of interest to the particular persons viewing the profiles.

The technology disclosed also relates to enhancing user experience to viewers of online social profiles. In particular, it relates to creating person-oriented personas of online social profiles of users for respective persons in users' online social networks based on shared interests. The person-oriented personas supply augmenting content from sources external to the online social networks, which is determined to be of interest to the particular persons viewing the profiles.

### RELATED APPLICATION

The application claims the benefit of U.S. provisional Patent Application No. 61/868,020, entitled, “Systems and Methods of Presenting Personalized Personas in Online Social Networks,” filed on Aug. 20, 2013 (Attorney Docket No. SALE 1061-2/1223PROV). The provisional application is hereby incorporated by reference for all purposes.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also correspond to implementations of the claimed technology.

Social network platforms have revolutionized the way users communicate and share information with each other. On these platforms, users share a substantial amount of personal and professional information along with their likes, interests, and hobbies. However, user interests and preferences are not being used to streamline the information that is presented to the users, thus resulting in information overload and declining user experience.

An opportunity arises to personalize and enhance viewer experience for viewer of online social networks by facilitating easy and efficient access to information that is most interesting to them. Improved user experience and engagement and higher user satisfaction and retention may result.

### SUMMARY

The technology disclosed relates to providing personalized experience to viewers of online social profiles. In particular, it relates to creating person-specific personas of a user's online social profiles to be viewed by respective persons in the user's online social networks based on shared interests. The person-specific personas prominently display content selected from a user's profile that is determined to be of interest to the particular persons viewing the profiles.

The technology disclosed also relates to enhancing user experience to viewers of online social profiles. In particular, it relates to creating person-oriented personas of online social profiles of users for respective persons in users' online social networks based on shared interests. The person-oriented personas supply augmenting content from sources external to the online social networks, which is determined to be of interest to the particular persons viewing the profiles.

Other aspects and advantages of the present technology can be seen on review of the drawings, the detailed description and the claims, which follow.

### BRIEF DESCRIPTION OF THE DRAWINGS

The included drawings are for illustrative purposes and serve only to provide examples of possible structures and process operations for one or more implementations of this disclosure. These drawings in no way limit any changes in form and detail that may be made by one skilled in the art without departing from the spirit and scope of this disclosure. A more complete understanding of the subject matter may be derived by referring to the detailed description and claims when considered in conjunction with the following figures, wherein like reference numbers refer to similar elements throughout the figures.

FIG. 1 shows an example persona generation environment.

FIG. 2 illustrates one implementation of a user's profile in an online social network.

FIG. 3 shows one implementation of a first viewer's profile in an online social network.

FIG. 4 is one implementation of a second viewer's profile in an online social network.

FIG. 5 illustrates one implementation of an evaluation of interactions between the user and viewers.

FIG. 6 shows one implementation of a professional persona of the user's profile that is presented to the first viewer.

FIG. 7 is one implementation of a personal persona of the user's profile that is presented to the second viewer.

FIG. 8 illustrates an example augmented persona of the user's profile that is created for the second viewer.

FIG. 9 shows one implementation of a plurality of objects that can be used to store persona data.

FIG. 10 is a flowchart of one implementation of providing personalized user experience to viewers of a user's profile.

FIG. 11 is a flowchart of one implementation of enhancing user experience for viewers of a user's profile.

FIG. 12 is a block diagram of an example computer system for generating personalized personas.

### DETAILED DESCRIPTION

The following detailed description is made with reference to the figures. Sample implementations are described to illustrate the technology disclosed, not to limit its scope, which is defined by the claims. Those of ordinary skill in the art will recognize a variety of equivalent variations on the description that follows.

Examples of systems, apparatus, and methods according to the disclosed implementations are described in an online social networking context. The examples of social profiles and personas are being provided solely to add context and aid in the understanding of the disclosed implementations. In other instances, examples may include business profiles, commercial websites, and enterprise management systems. Other applications are possible, such that the following examples should not be taken as definitive or limiting either in scope, context or setting.

The technology disclosed relates to providing personalized user experience to viewers of online social profiles by using computer-implemented systems. The technology disclosed can be implemented in the context of any computer-implemented system including a database system, a multi-tenant environment, or the like. Moreover, this technology can be implemented using two or more separate and distinct computer-implemented systems that cooperate and communicate with one another. This technology can be implemented in numerous ways, including as a process, a method, an apparatus, a system, a device, a computer readable medium such as a computer readable storage medium that stores computer readable instructions or computer program code, or as a computer program product comprising a computer usable medium having a computer readable program code embodied therein.

As used herein, the “identification” of an item of information does not necessarily require the direct specification of that item of information. Information can be “identified” in a field by simply referring to the actual information through one or more layers of indirection, or by identifying one or more items of different information which are together sufficient to determine the actual item of information. In addition, the term “specify” is used herein to mean the same as “identify.”

As used herein, a given signal, event or value is “dependent on” a predecessor signal, event or value if the predecessor signal, event or value influenced the given signal, event or value. If there is an intervening processing element, step or time period, the given signal, event or value can still be “dependent on” the predecessor signal, event or value. If the intervening processing element or step combines more than one signal, event or value, the signal output of the processing element or step is considered “dependent on” to each of the signal, event or value inputs. If the given signal, event or value is the same as the predecessor signal, event or value, this is merely a degenerate case in which the given signal, event or value is still considered to be “dependent on” the predecessor signal, event or value. “Responsiveness” of a given signal, event or value upon another signal, event or value is defined similarly.

The technology disclosed includes systems and methods that offer a flexible approach to personalizing and enhancing a viewer's experience. Specifically, by applying the technology disclosed, key attributes of social data can be efficiently separated from noise. As the volume of information flowing in online social networks continues to increase, the need for automated tools that can assist persons in receiving information valuable to them also increases. The information overload created by a multitude of information sources makes it difficult for a person to know what piece of information is more suitable, relevant or appropriate to his desires and needs.

The technology disclosed provides techniques that enable users to present personas that are well-matched to respective persons in their online social networks. Users invest substantial time and effort in building their online social profiles. Using the technology disclosed, users can establish numerous personas to represent themselves. For instance, users may maintain professional personas for their work related interactions and personal personas for other interests. Current online social networks offer limited tools for automatically enhancing the viewing experience of online social profiles dependent on the viewers' interests and preferences.

The technology disclosed identifies shared interests between a user and other persons in the user's online social network. Using the technology disclosed, a person viewing the user's online social profile, the “viewer,” can view a persona matched to interests which he shares with the user. The viewer can also receive additional content, which satisfies his interests, from sources external to the online social network.

The technology disclosed also generates focused personas that are specifically directed to a particular person viewing the user's online social profile (based on shared interests between the user and the person). Feed items that are determined to be of interest to both, the user and the person, are prioritized and exclusively displayed in the focused personas. The shared interests are automatically identified by—comparing the user's profile with that of the person's and determining matching profile information. They can be specially selected by the user for a particular viewer.

In one implementation, online interactions between the user and the person are evaluated to identify shared themes and concepts in the interactions, which are further used to establish shared interests between the user and the person. In one instance, semantic analysis is used to determine common focus topics in the message exchanges. In another implementation, the technology disclosed also uses tags that categorize content in social profiles to determine shared interests.

Furthermore, interests of particular persons viewing a user's profile are also determined based on influences of online social network's objects on the persons. Once identified, these interests are used to generate augmented personas of the user's profile for viewing by the particular persons, which include content assembled from sources external to the online social networks. The external content is provided by a variety of sources, including third party applications, games and services.

### Persona Generation Environment

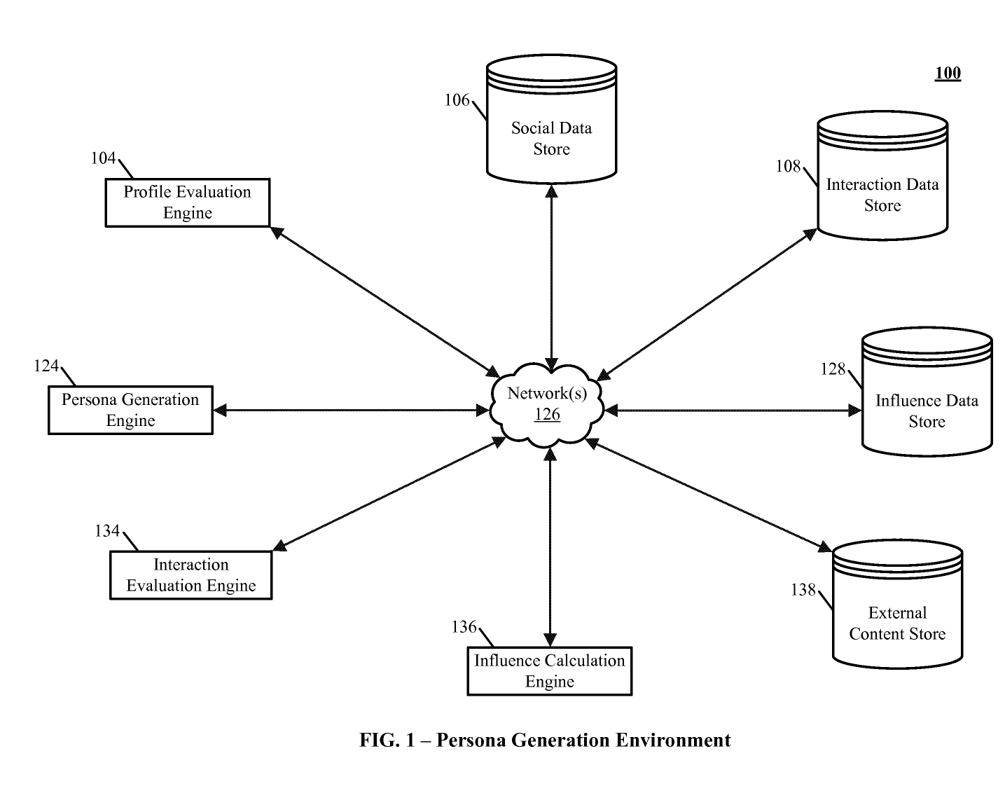

FIG. 1 shows an example persona generation environment 100 in which focused personas of a user's online social profile are generated for viewing by particular persons in the user's online social network. FIG. 1 includes a profile evaluation engine 104, persona generation engine 124, interaction evaluation engine 134, influence calculation engine 136, and network(s) 126. Data can be stored in the various data stores shown, including social data store 106, interaction data store 108, influence data store 128, and external content store 138. In other implementations, environment 100 may not have the same elements or components as those listed above and/or may have other/different elements or components instead of, or in addition to, those listed above. The different elements or components can be combined into single software modules and multiple software modules can run on the same hardware.

In some implementations, network(s) 126 can be any one or any combination of Local Area Network (LAN), Wide Area Network (WAN), WiFi, telephone network, wireless network, point-to-point network, star network, token ring network, hub network, peer-to-peer connections like Bluetooth, Near Field Communication (NFC), Z-Wave, ZigBee, or other appropriate configuration of data networks, including the Internet.

In some implementations, the engines can be of varying types including workstations, servers, computing clusters, blade servers, server farms, or any other data processing systems or computing devices. The engines can be communicably coupled to the databases via a different network connection. For example, profile evaluation engine 104 can be coupled via the network 126 (e.g., the Internet), persona generation engine 124 can be coupled via a direct network link, and influence calculation engine 136 can be coupled by yet a different network connection.

In some implementations, datastores can store information from one or more tenants into tables of a common database image to form a multi-tenant database system (MTS). A database image can include one or more database objects. In other implementations, the databases can be relational database management systems (RDBMSs), object oriented database management systems (OODBMSs), distributed file systems (DFS), no-schema database, or any other data storing systems or computing devices.

Social personas are online identities of users on online social networks that include social media content like social profiles, social feeds, and social handles. This social media content is stored in social data store 106. In one implementation, social personas include biographic information, such as name, title, phone number, location, address, birthday, and photos of the users. In another implementation, social personas specify interests, hobbies, and likings of the users such as favorite websites, videos, music, games, books, or activities.

Personalized personas are customized to include content dependent on shared interests between the owner of a profile (user) and the person viewing the profile. Shared interests are obtained by comparing the user's profile to the viewer's profile. In one implementation, the profile evaluation engine 104 categorizes profile information so that it can be compared with profile information in another profile. Categorization can be done using keywords or tags that identify sections of a profile, including background, skills, experience, education, activities, job title, groups, likes, about, applications, notes, interests, books, music, check-ins, hobbies, and personal.

In some implementations, the profile evaluation engine 104 can apply various natural language processing algorithms to stratify the profile information into categories and tags. Examples include generating metadata annotations (e.g., paragraph identification, tokenization, sentence boundary detection, part-of-speech tagging, clause detection, phrase detection (chunking), syntactic analysis, word sense disambiguation, and semantic analysis.

Once categorized, information in the user's profile is compared to information in a viewer's profile that is similarly categorized. In one implementation, categorized information can be compared by evaluating the content for selected keywords or tags. In other implementations it can be compared by performing semantic analysis on the content and then comparing it, for instance by identifying specific sports teams like the SF Giants in a user's profile and the Boston Red Sox in a viewer's profile. The analysis can identify both teams as baseball teams and infer that the user and viewer share a common interest in baseball.

Interaction data store 108 includes social feeds such as messages, posts, status updates, likes, replies, stories, shares, or comments exchanged between users of online social networks. For example, social feeds can include text inputs such as statements, questions, emotional expressions, answers, reactionary emotional expressions, indications of personal preferences, status updates, and hyperlinks. As another example, social feeds can include file uploads, such as presentations, documents, multimedia files, and the like.

Online user interactions are analyzed by the interaction evaluation engine 134 using tags, keyword and/or semantic analysis to identify common themes or concepts prevalent in the interactions. An example of an online user interaction is a message thread or series of posts exchanged between a user and a viewer of the user's profile. The thread can include shared references to a given topic that can be used as a basis for inferring shared interests. For instance, if both parties are discussing selling to the same customer or attending the same entertainment event, then the corresponding sales industry or entertainment source can be identified as a shared interest between the two parties. In other implementations, shared references can be used to discover recurring themes that pervade direct interactions or other content related to shared interests, referred to as “focus topics.”

In one implementation, the frequency of occurrence of a particular shared interest in both the user's and viewer's profile can be used to prioritize content that is presented to a viewer in a personalized persona. Frequency can be dependent on the number of times a tag or keyword occurs, or by counting the number of times a given topic or concept occurs. In other implementations, the amount of content a user and/or viewer posts or otherwise makes available can be used as an indicator of a level of interest. For text, the content can be measured in words or characters. For images or videos, a simple count can be used. For videos, the playing time can be used to indicate a level of interest, according to one implementation.

Influence calculation engine 136 recognizes the speed and quantity by which users spot, share, and endorse content on any specific topic. In one implementation, content recommendation decisions of users such as likes, shares, retweets, and comments. can be used to measure users' interest in a specific topic. In another implementation, a particular object's influence on a user can be determined by the amount of object-related content posted by the user. In yet another implementation, the object's influence can be determined by the number of reactions made by the user in response to postings of object-related content. The determined influence is stored in influence data store 128.

A user's profile can include messages, posts, and comments in which the user discusses or reviews an object and expresses an opinion, suggestion or observation regarding the object. For instance, the user can review a recent purchase, such as a book, positively and/or rate it highly. In one implementation, the influence calculation engine 136 can use various natural language processing algorithms, like semantic analysis, to identify the object and determine the user's actions with regards to object-related content. If the user posts many reviews and/or discussion related to the object and/or reacts to posts made by others regarding the object, then the number of posts and/or reactions can also be used to determine the level of related influence of the object on the user.

Persona generation engine 124 can also identify and cluster focus topics that have been extracted from analyzing online user interactions and comparing profiles of the user and the viewer. In one implementation, clustering can be used to combine related focus topics into a group that includes the related focus topics as a more general topic. For instance, if the names of several baseball teams are identified, then these can be clustered into the general topic of baseball. Once focus topics and clusters of focus topics are identified, substitutes and alternatives of a particular focus topic or cluster can be identified. As an example if baseball and football have been identified as focus topics then the topic of sports can be used as a more general alternative or substitute to broaden the range of available content for generating personas.

External content store 138 includes content referenced from sources external to the online social network dependent on the identified interests of the respective users. Examples of external content store 138 include web pages, games, applications, music, videos, and images. that are determined to interest the users. In one implementation, content can be streamed from third party applications like YouTube, Amazon, Reuters, and Zynga. In another implementation, it can be used independently or combined with other data to form an intuitive social framework in the user's profile. In another implementation, external content store 138 can be copied directly, incorporated, or embedded into a user's profile or recommended or referenced via a hyperlink or other descriptor that provides for its location and retrieval.

Other examples of alternative and substitute information include third-party applications, games, and services. Using golf as an example, there are many online golf applications which can be included in a persona that highlights golf such as GolfLogix, Golfshot, FreeCaddie, and the like. Further, some implementations can include third-party games and services related to golf like Work Golf Tour, and Turbo Golf Other examples can include: audios and videos that suggest ways to improve a golf swing; online journals that track golf events; meme images related to golf; or links to golf apparel and equipment stores.

### User and Viewer Profiles

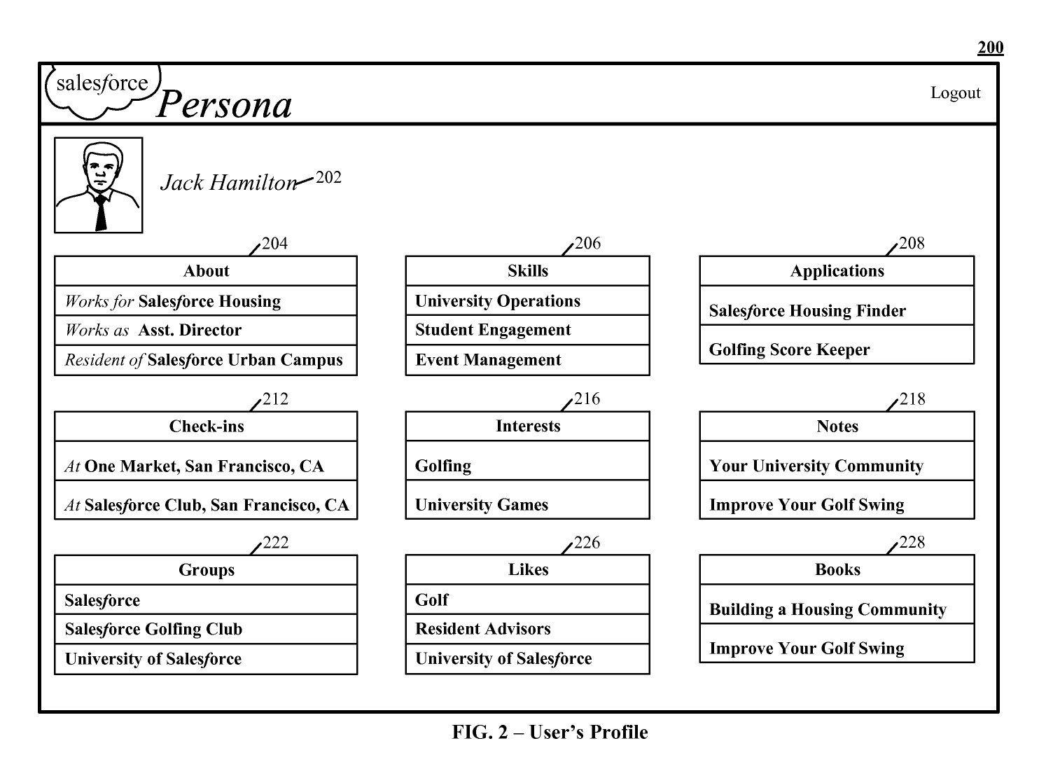

FIGS. 2-4 are one implementation of respective example profiles of a user and two different persons viewing the user's profile. Several categories of profile information are shown in FIGS. 2-4, including, about 204, skills 206, applications 208, check-ins 212, interests 216, notes 218, groups 222, likes 222, and books 228. Other types and categories of profile information can be used, including background, job history, personal, endorsements, recommendations, circles, badges, awards, hobbies, activities, and events. In other implementations, profiles 200-400 may not have the same profile information items as those listed above and/or may have other/different profile information items instead of, or in addition to, those listed above.

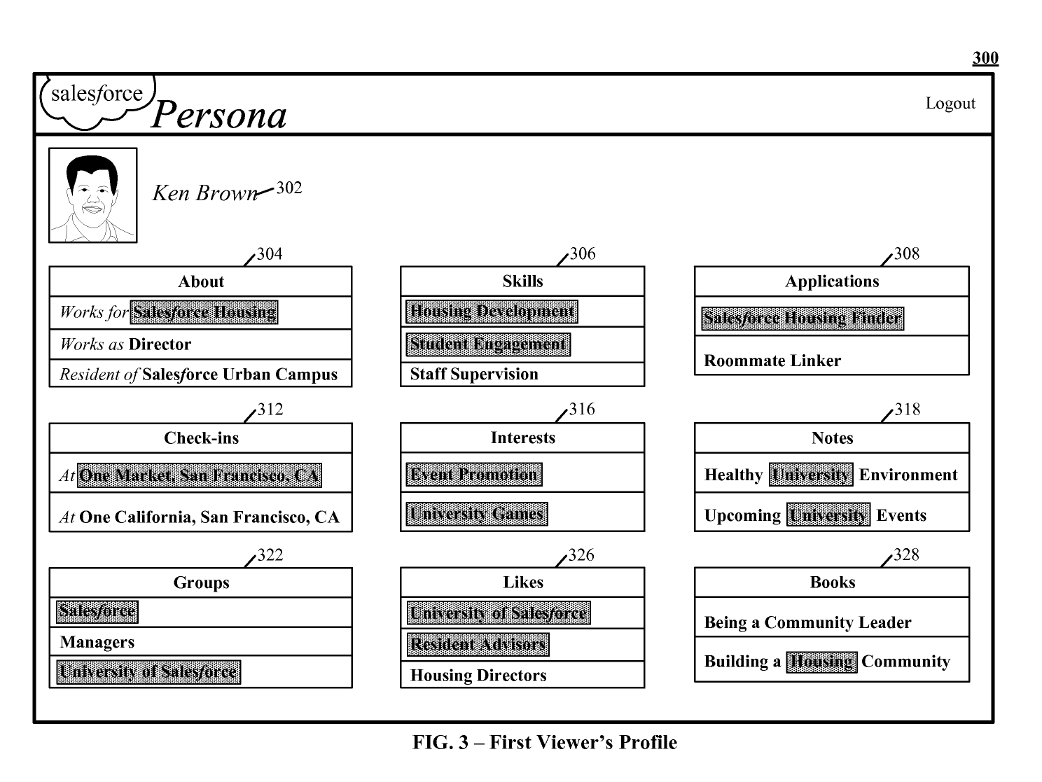

In one implementation, FIGS. 2-4 include various category items that are tagged. For instance, in category 204, “about,” the following three tags appear: “Works for,” “Works as” and “Resident of.” These tags are used to identify shared interests between the user 202 and viewers 302 and 402 by comparing the respective tag entries in user's profile 200 with corresponding tag entries in viewers' profiles 300 and 300. Specifically, FIGS. 2-3 show a comparison between profiles of user Jack Hamilton 202 and viewer Ken Brown 302. In one implementation, the comparison includes using the “Works for” tag in the respective “about” categories 204 and 304 to highlight shared interests of Jack Hamilton 202 and Ken Brown 302 and thus concluding that they both work for Salesforce Housing.

Similarly, in other implementations, additional shared interests can be identified by comparing the highlighted items in FIG. 3 with their counterparts in FIG. 2. This includes evaluating the various categories shown in FIGS. 2-3 and identifying keywords specified in both the profiles (300 and 400). For example, FIGS. 2-3 show that both Jack 202 and Ken 302 work at the same Salesforce location and are members of the Salesforce University, and further both share a strong interest in housing and university related activities and events.

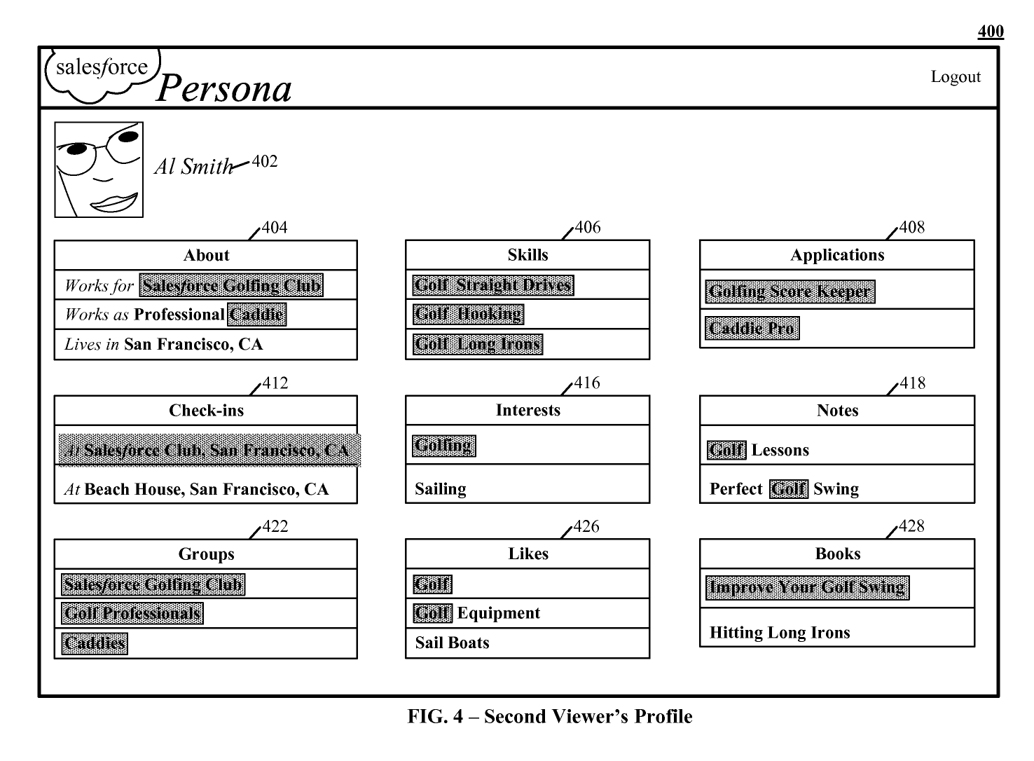

In FIG. 4, profile 400 of a second viewer, Al Smith 402, is compared with that of Jack Hamilton 202. As show in FIG. 4, golf is a major theme in Al Smith's profile 400. This is indicated by the frequency of occurrence of the keyword “golf,” which appears in categories 404, 406, 408, 412, 416, 418, 422, 426 and 428. Furthermore, profile 200 of user Jack Hamilton 202 also shows golf as an entry under the “interests” category 212. This information can be used to conclude that golf is an interest shared by both the individuals. Other approaches for comparing profiles can be applied, including semantic analysis, paragraph identification, tokenization, sentence boundary detection, part-of-speech tagging, clause detection, phrase detection (chunking), syntactic analysis, and word sense disambiguation.

### Interactions and Semantic Analysis

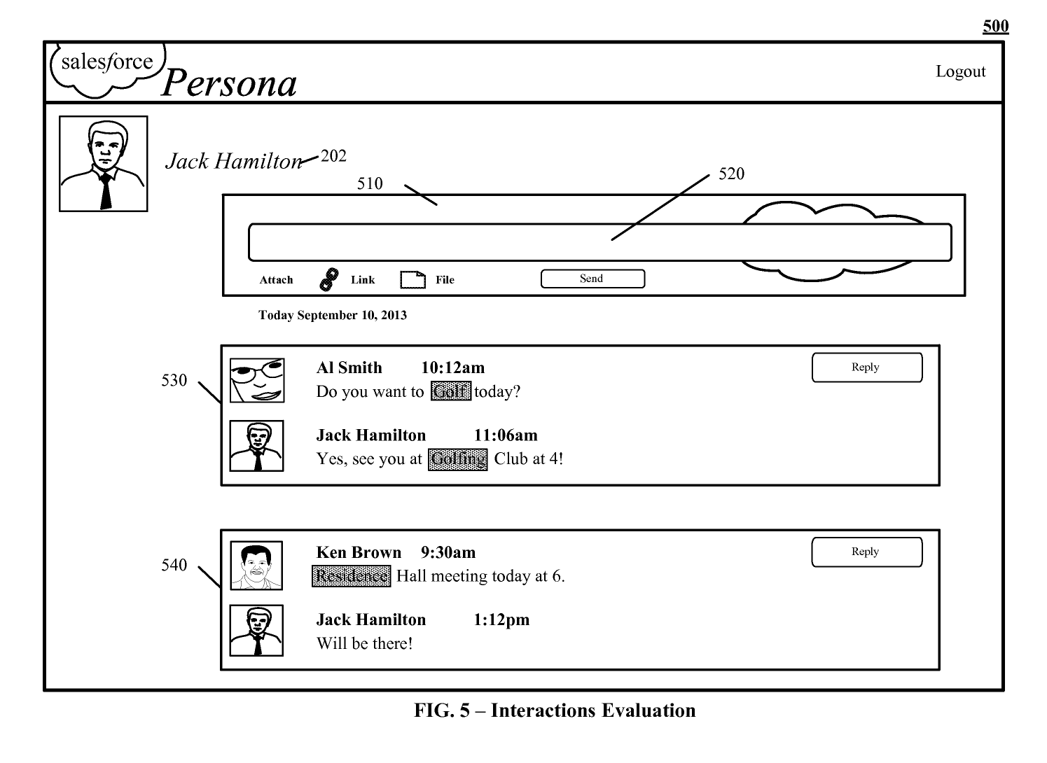

FIG. 5 illustrates one implementation of an evaluation 500 of interactions between the user 202 and viewers 302 and 402. FIG. 5 illustrates the use of semantic analysis on feeds items 530 and 540 to identify shared interests between user 202 and viewers 302 and 402. In one implementation, semantic analysis includes inferring themes and concepts from particular words appearing in text. In another implementation, it includes using parser and/or syntax analyzer that selects particular words or phrases, and/or identifies parts of speech within text. In other implementations, evaluation 500 may not have the same feed items as those listed above and/or may have other/different feed items instead of, or in addition to, those listed above.

In particular, FIG. 5 shows interaction evaluation 500 using an example of two message exchanges, 530 and 540. Jack Hamilton 202 uses text field 520 within screen pane 510 to exchange messages with two other users, Al Smith 402 and Ken Brown 302. In the first interaction 530, Al Smith 402 uses the word “golf” and Jack Hamilton 202 uses the word “golfing.” Applying the semantic analysis, these words can be identified as having the same root, golf, which can then be further identified as a shared interest.

Similarly, in message exchange 540, the word “residence” appears in the text posted by Ken Brown 302, which has the same root or concept as the word “resident” (category 226) in Jack Hamilton's profile 200. In one implementation, the similar keywords can be used to identify shared interests between Jack Hamilton 202 and Ken Brown 302, to further determine which select parts of Jack's profile 200 are to be presented to the first viewer, Ken Brown 302.

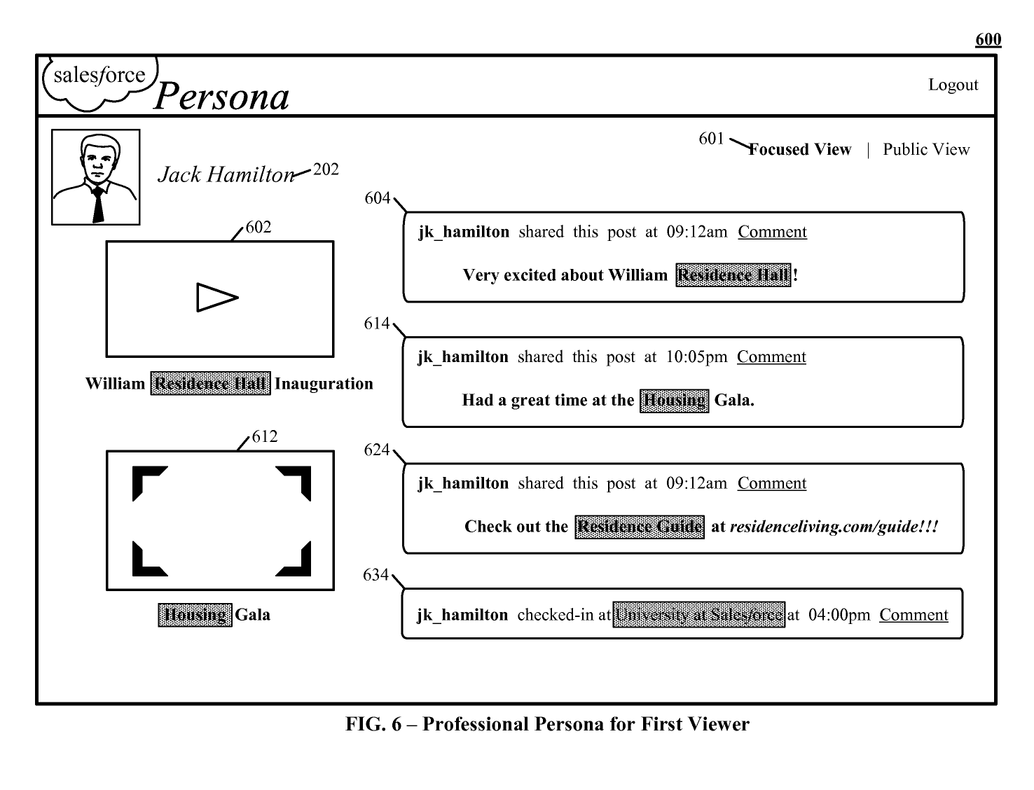

FIG. 6 shows one implementation of a professional persona 600 of the user's profile that is presented to the first viewer. Professional persona 600 includes feed items 604, 614, 624, and 634, video 602, and image 612 that are selected dependent on the identified shared interests between Jack Hamilton 202 and Ken Brown 302 and then displayed to viewer Ken Brown 302 upon viewing Jack Hamilton' profile 200. In another implementation, semantic analysis links the concepts of housing and residence for both parties, and can also identify both Jack Hamilton 202 and Ken Brown 302 as professional colleagues since they both work for Salesforce housing, as shown in category 204 of FIG. 2 and category 304 of FIG. 3. In yet another implementation, the concept of work can be related to professional persona 600, or given as a default rule to a semantic analyzer.

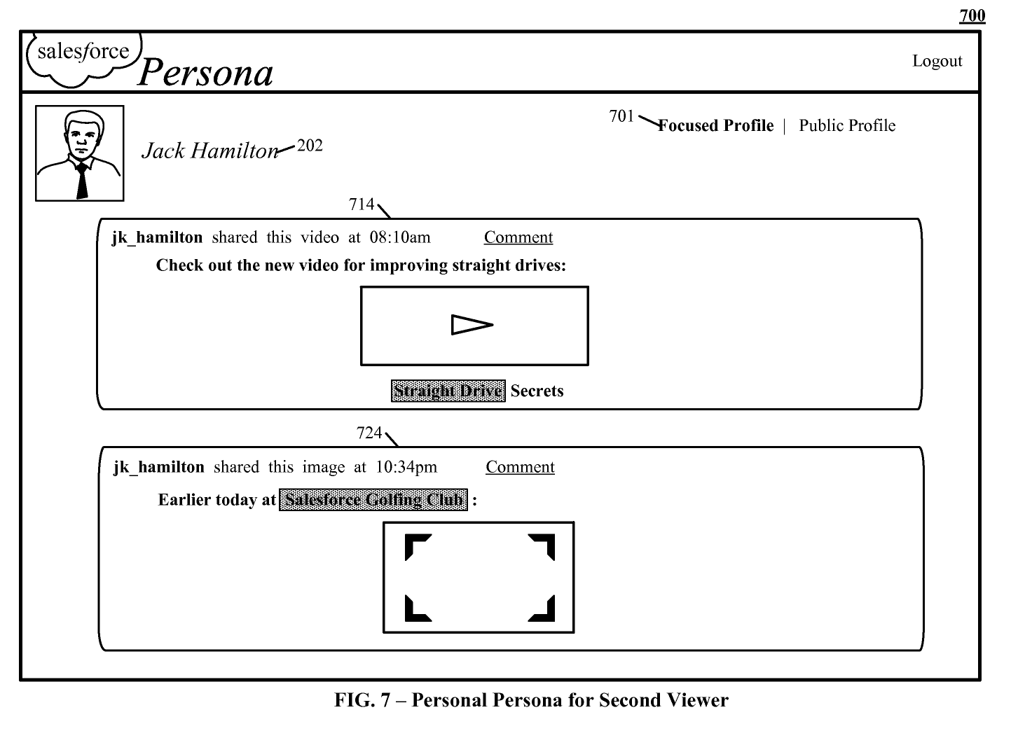

FIG. 7 is a personal persona 700 of Jack Hamilton's profile 200, as viewed by the second viewer Al Smith 402 and generated dependent on the identified shared interests between Jack Hamilton 202 and Al Smith 402. In particular, focused profile 701 includes two content items, video 714 and a photo 724. In other implementations, personal persona 700 may not have the same content items as those listed above and/or may have other/different content items instead of, or in addition to, those listed above.

The sources of the video and the photo can be included in profile information or can be facilitated via hyperlinks in the online social network. The content items 714 and 724 are selected from Jack Hamilton's profile 200 and presented to Al Smith 402 upon viewing Jack Hamilton's profile 200. The selection of the content items is dependent upon shared interests between the two users. For instance, the title of the video 714 is “Straight Drive Secrets,” which is conceptually related to golf (previously identified shared interest). Also, the reference to the “Salesforce Golfing Club” in the caption of image 724 includes the word “golfing,” which too is related to golf.

### Persona Augmentation

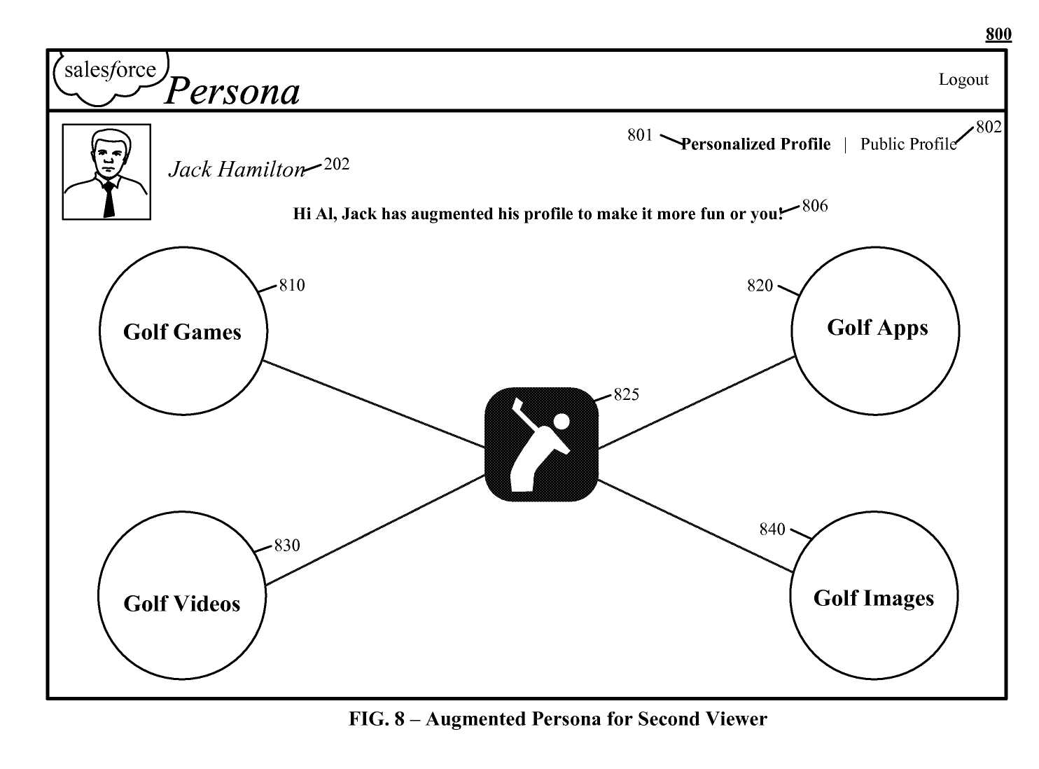

FIG. 8 illustrates an example augmented persona 800 of the user's profile 202 that is created for the second viewer 402. FIG. 8 shows an example of an augmented persona 800 with a descriptive comment 806. A personalized profile 801, as shown in FIG. 8, can be generated by obtaining content external to a profile such as games 810, applications 820, videos 830, and images 840 that interest the second viewer 402. In this example, content related to golf has been used, since golf was identified as a particular interest of the second viewer 402, Al Smith. In other implementations, persona 800 may not have the same profile information items as those listed above and/or may have other/different profile information items instead of, or in addition to, those listed above.

When the second viewer 402 views user's profile 202, the profile can be augmented with external content that is determined to be of interest to viewer 402. External content can be streamed from sources external to the online social network such as news websites, gaming websites, video streaming, applications store, or microblogs. In one implementation, a message 806 can be displayed to the viewer 402 that the user 202 has personalized his profile specifically for the viewer 402.

In one implementation, the viewer's interest, based on which the augmented profile is created, can be graphically displayed to the viewer through images, logos, or icons such as the golf logo 825 shown in FIG. 8. In this example, Jack Hamilton's profile 200 is augmented to include external content such as golf games 810, golf applications 820, golf videos 830, and golf images 840 for viewing by Al Smith 402, whose interest has been identified as golf based on the profile evaluation and interaction evaluation described above. In another implementation, user 202 can prioritize, qualify, and/or approve content that is used to augment his profile 200 for a particular viewer. In yet another implementation, viewer 402 can be presented with an option to concurrently view the personalized profile 801 that has been specially or exclusively generated for him and the default profile 802, which is viewable to other users.

### Persona Data Schema

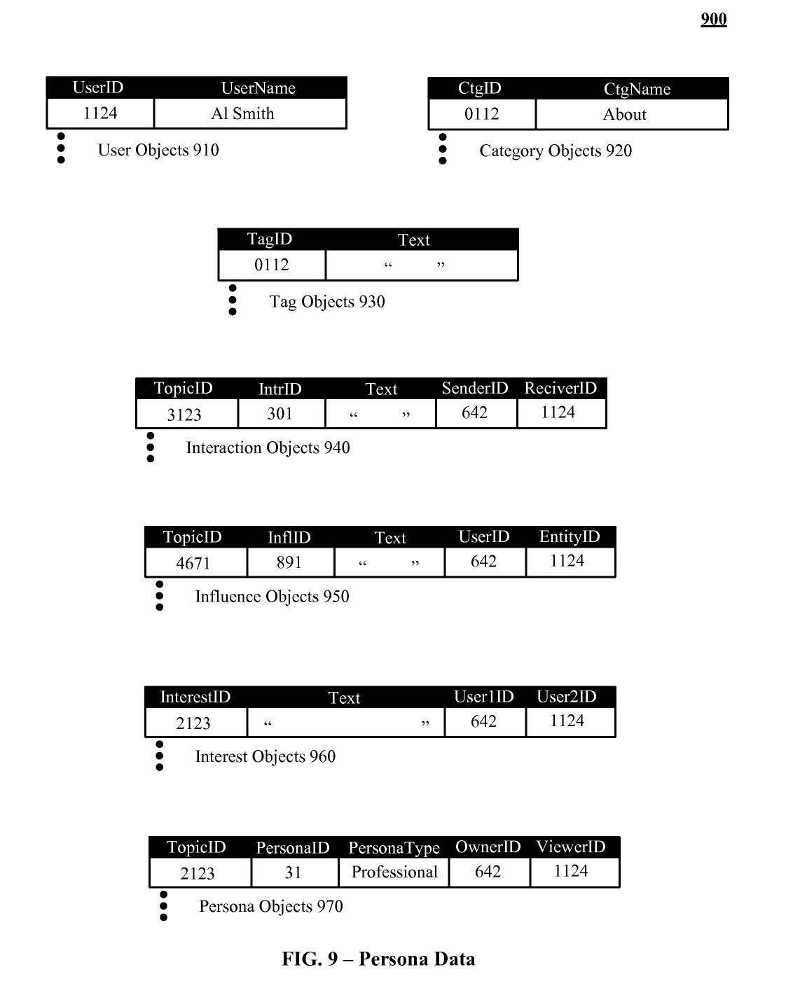

FIG. 9 shows one implementation of a plurality of objects 900 that can be used to store persona data and/or to reproduce a persona generated for a specific viewer. As described above, this and other data structure descriptions that are expressed in terms of objects can also be implemented as tables that store multiple records or object types. Reference to objects is for convenience of explanation and not as a limitation on the data structure implementation. FIG. 9 shows users objects 910, category objects 920, tag objects 930, interaction objects 940, influence objects 950, interest objects 960, and persona objects 960. In other implementations, objects 900 may not have the same objects, tables, entries or fields as those listed above and/or may have other/different objects, tables, entries or fields instead of, or in addition to, those listed above.

User objects 910 uniquely identify the users of online social networks using “UserID” field and provide supplemental information about the users like usernames and unified resource locators (URLs) of users' profiles in the online social networks. Category objects 920 include various categories of user profiles shown in FIG. 2, including about, skills, application, check-in, interest, notes, groups, likes, books, background, job history, personal, endorsements, recommendations, circles, badges, awards, hobbies, activities, and events.

Tag objects 930 include keywords and phrases (“Text”) that have been identified as tags for various categories. In one implementation, tags can be uniquely identified using “TagID” field. In another implementation, the corresponding categories for the tags can be identified using a “CategoryID” field.

Interaction objects 940 tracks user interactions on the online social networks by assigning them unique identifiers, grouping them into topics (TopicID), and identifying the sending (SenderID) and receiving parties (ReceiverID). In another implementation, interaction objects 940 can include fields that specify a thread ID for a related collection of message exchanges, a message ID for each individual message, a time stamp for each message, an author ID for each message, and the actual content of the message.

In one implementation, influence objects 950 can be used to represent and store objects that influence a user. A unique identifier for the influencer object and descriptive text can be included, along with an identifier for the associated user and a specific entity. The entity can be a topic, another user, group, product, or service that influences the associated user.

Interest objects 960 include keywords and phrases (“Text”) that identify shared and individual interests of the users. In one implementation, interests can be uniquely identified using “InterestID” field. In another implementation, the corresponding users for the interests can be identified using “User1ID” and/or “User2ID.”

Persona objects 970 uniquely identify personas generated for particular viewers using “PersonaID” field. In one implementation, persona objects 970 can specify the interest topic dependent on which a persona is generated through “TopicID” field. In another implementation, the type of the persona (personal, professional, augmented) can be identified in the “PersonaType” field. In yet another implementation, the user whose profile is augmented can be identified using the “OwnerID” field and the viewer for whom the user's profile is augment is identified using the “ViewerID” profile.

### Flowchart of Providing Personalized User Experience

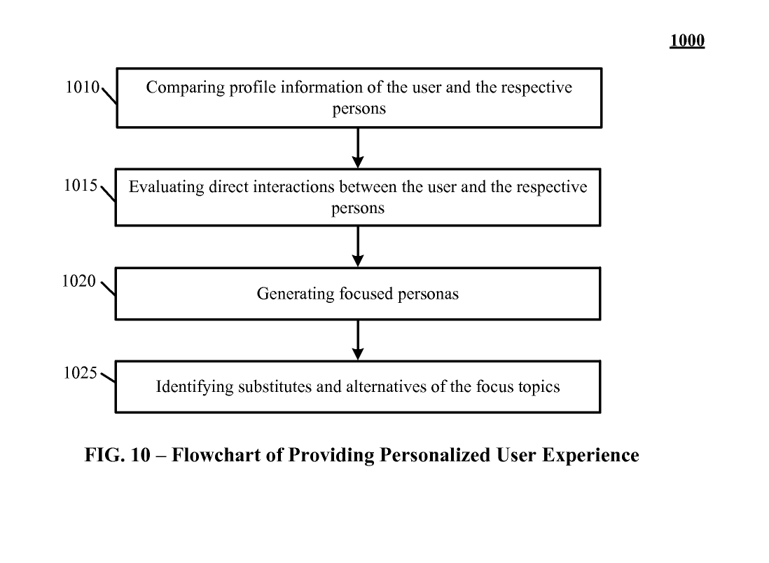

FIG. 10 is a flowchart 1000 of one implementation of providing personalized user experience to viewers of a user's profile. Flowchart 1000 can be implemented at least partially with a database system, e.g., by one or more processors configured to receive or retrieve information, process the information, store results, and transmit the results. Other implementations may perform the actions in different orders and/or with different, fewer or additional actions than those illustrated in FIG. 10. Multiple actions can be combined in some implementations. For convenience, this flowchart is described with reference to the system that carries out a method. The system is not necessarily part of the method.

At action 1010, profile information of a user and respective persons specified in the user's online social network are compared by a profile evaluation engine 104. Profile information can include personal information, professional information, or any other information related to a user or a person in the user's online social network. The information can be written textual information, video information, digital pictures, audio information or other types of information stored in digital form. Examples include names, locations, posts, feed items, videos, images, job histories, employment information, awards, interests, activities, groups, circles, reviews, likes, and education.

In one implementation, profile information can include descriptive categories, tags, keywords, phrases, icons, or other identifiers that stratify the profile information. FIG. 2 provides examples of several typical profile information categories labeled with tags, keywords and/or phrases.

Content included in the profile information categories can be compared between a user's profile and a viewer's profile to identify shared interests between the user and the viewer. Such a comparison can be carried out by identifying similar words, phrases and/or concepts. In some implementations, a simple word-for-word comparison can be used. In other implementations, paragraph identification, tokenization, sentence boundary detection, part-of-speech tagging, clause detection, phrase detection (chunking), syntactic analysis, word sense disambiguation, and semantic analysis. can be used. In other implementations, tags can be used to identify shared interests between the user and the viewer by comparing the tag data through above described techniques.

At action 1015, an interaction evaluation engine 134 evaluates direct interactions on an online social network between the user and respective persons viewing the user's profile. Examples of such direct interactions include message exchanges described for FIG. 5, comments by one party made on posts or blogs of the other party, or other communications such as comments, replies, shares, posts, and likes. In one implementation, natural language processing algorithms, like semantic analysis, can be used to identify common themes in direct interactions, as described in FIG. 5. In another implementation, words and concepts extracted and/or inferred from direct interactions can be compared to the same in the user's and viewer's profile to confirm that the identified common themes are interests shared by the user and the viewer.

At action 1020, focused personas are generated for the viewers based on the identified shared interests between the viewers and the user. These personas prioritize content dependent on the frequency of occurrence of keywords and tags that indicated shared interests. For instance, if the word “golf” occurs more frequently than other words in both—the user's profile and viewer's profile, then content related to golf can be emphasized or displayed at the top in the focused persona generated for the viewer.

At action 1025, alternative focus topics and/or substitutes are found dependent on the identified keywords, tags, phrases, and concepts. In one implementation, if the expressed interest is in a sport like lawn bowling and little content is available, then a similar sport like bocce ball is selected to provide an appropriate substitute for finding content of interest to the viewer. In another implementation, focus topics along with their substitutes and alternatives can be clustered into topic families. For instance, if the identified shared interests revolve around football, baseball and basketball, then the more general topic of sports can be used to cluster together these shared interests. Since all three sports are considered popular sports and regularly tracked by the media, general sports content is likely to be of interest to a viewer of these individual focus topics.

### Flowchart of Enhancing User Experience

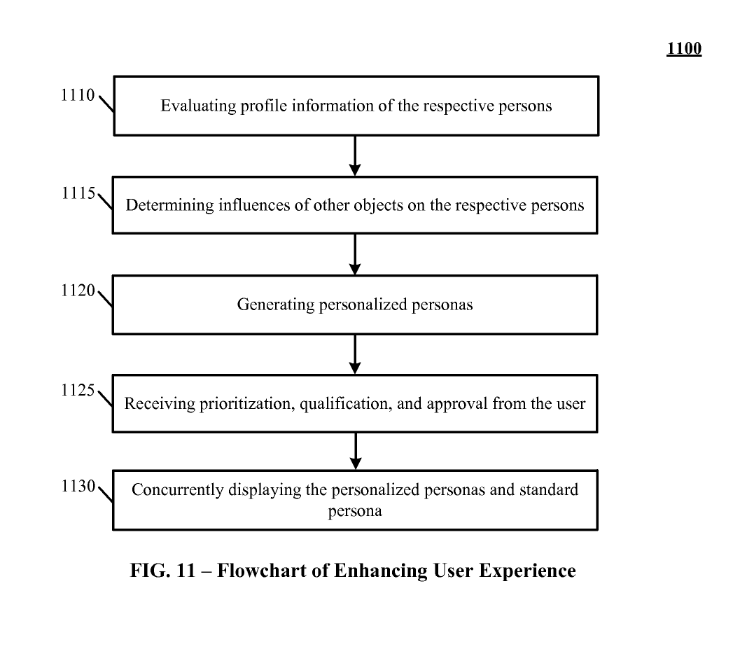

FIG. 11 is a flowchart 1100 of one implementation of enhancing user experience for viewers of a user's profile. Flowchart 1000 can be implemented at least partially with a database system, e.g., by one or more processors configured to receive or retrieve information, process the information, store results, and transmit the results. Other implementations may perform the actions in different orders and/or with different, fewer or additional actions than those illustrated in FIG. 11. Multiple actions can be combined in some implementations. For convenience, this flowchart is described with reference to the system that carries out a method. The system is not necessarily part of the method.

At action 1110, profiles of respective persons in a user's online social network are evaluated. The evaluation includes identifying the persons' interests by analyzing the information in their profiles. In one implementation, the profile evaluation engine 104 categorizes profile information using keywords or tags that identify sections of a profile, including background, skills, experience, education, activities, job title, groups, likes, about, applications, notes, interests, books, music, check-ins, hobbies, and personal. In another implementation, categorized information can be compared by evaluating the content for selected keywords or tags. In some implementations, the profile evaluation engine 104 can apply various natural language processing algorithms to stratify the profile information into categories and tags. Examples include generating metadata annotations (e.g., paragraph identification, tokenization, sentence boundary detection, part-of-speech tagging, clause detection, phrase detection (chunking), syntactic analysis, word sense disambiguation, and semantic analysis.) dependent on the text of the profile information.

At action 1115, influences of online social network's objects on the respective persons are determined. Examples of objects include topics, other users, groups, products, or services in the online social networks of the respective persons. In one implementation, this can be done by evaluating their posts, message exchanges, blogs and interactions with other entities in the online social network. Influence calculation engine 136 recognizes the speed and quantity by which users spot, share, and endorse content on any specific topic. In one implementation, content recommendation decisions of users such as likes, shares, retweets, and comments. can be used to measure users' interest in a specific topic. In another implementation, a particular object's influence on a user can be determined by the amount of object-related content posted by the user. In yet another implementation, the object's influence can be determined by the number of reactions made by the user in response to postings of object-related content.

At action 1120, personalized personas of user's social networking profile are generated for viewing by the respective persons dependent upon the identified interests of the respective persons. The personalized personas automatically augment content in user's social networking profile from sources external to the online social network. This results in providing a more interesting and informative user experience to the respective persons because they can receive additional content focused on their personal interests while viewing the user's profile. In one implementation, the content can be streamed or incorporated from sources external to the online social networks such as news websites, gaming websites, video streaming, applications store, microblogs and other third-party applications, games, and/or services. It can include online media, blogs, RSS feeds, videos, images and the like. In another implementation, the content can be included via hyperlinks or embedded into the user's profile.

At action 1125, a prioritization, qualification, and approval is received from the user for content augmented in the personalized personas of user's social networking profile dependent on the identified interests of the respective persons. In one implementation, a user can edit the content augmented by changing the emphasis features in the content and adding or deleting the content items.

At action 1130, a concurrently view that includes a default version of a user profile and a personalized version of the profile is presented to the person (viewer). The personalized version of the user's profile can generate an initial interest on the part of the person. Once the person becomes interested in the user whose profile he is viewing, the viewer can discover additional shared interests or focus topics by viewing a default or standard version of the user's profile. For instance, the person's initial interest can be piqued by the subject of golf emphasized on user's profile, but he may subsequently find that he also has a common business interest with the user.

### Computer System

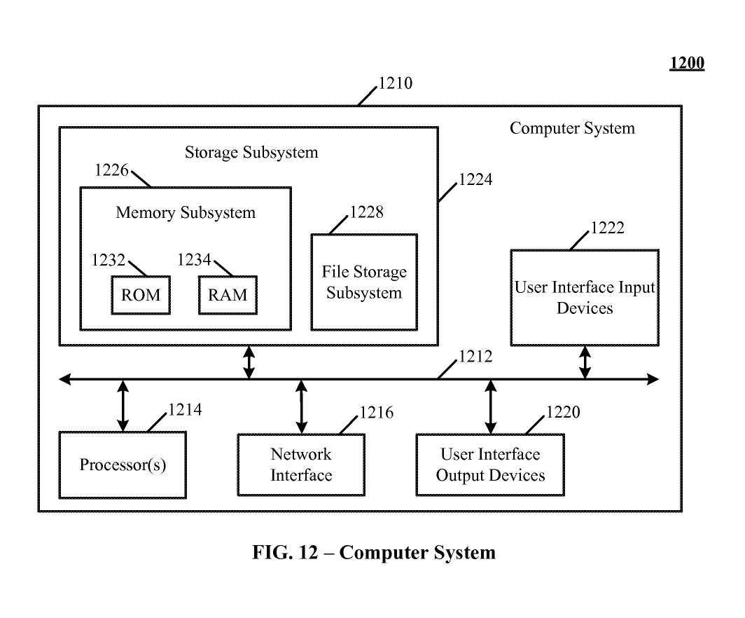

FIG. 12 is a block diagram of an example computer system 1200 for generating personalized personas. Computer system 1210 typically includes at least one processor 1214 that communicates with a number of peripheral devices via bus subsystem 1212. These peripheral devices can include a storage subsystem 1224 including, for example, memory devices and a file storage subsystem, user interface input devices 1222, user interface output devices 1220, and a network interface subsystem 1218. The input and output devices allow user interaction with computer system 1210. Network interface subsystem 1216 provides an interface to outside networks, including an interface to corresponding interface devices in other computer systems.

User interface input devices 1222 can include a keyboard; pointing devices such as a mouse, trackball, touchpad, or graphics tablet; a scanner; a touch screen incorporated into the display; audio input devices such as voice recognition systems and microphones; and other types of input devices. In general, use of the term “input device” is intended to include all possible types of devices and ways to input information into computer system 1210.

User interface output devices 1220 can include a display subsystem, a printer, a fax machine, or non-visual displays such as audio output devices. The display subsystem can include a cathode ray tube (CRT), a flat-panel device such as a liquid crystal display (LCD), a projection device, or some other mechanism for creating a visible image. The display subsystem can also provide a non-visual display such as audio output devices. In general, use of the term “output device” is intended to include all possible types of devices and ways to output information from computer system 1210 to the user or to another machine or computer system.

Storage subsystem 1224 stores programming and data constructs that provide the functionality of some or all of the modules and methods described herein. These software modules are generally executed by processor 1214 alone or in combination with other processors.

Memory 1226 used in the storage subsystem can include a number of memories including a main random access memory (RAM) 1230 for storage of instructions and data during program execution and a read only memory (ROM) 1232 in which fixed instructions are stored. A file storage subsystem 1228 can provide persistent storage for program and data files, and can include a hard disk drive, a floppy disk drive along with associated removable media, a CD-ROM drive, an optical drive, or removable media cartridges. The modules implementing the functionality of certain implementations can be stored by file storage subsystem 1228 in the storage subsystem 1224, or in other machines accessible by the processor.

Bus subsystem 1212 provides a mechanism for letting the various components and subsystems of computer system 1210 communicate with each other as intended. Although bus subsystem 1212 is shown schematically as a single bus, alternative implementations of the bus subsystem can use multiple busses.

Computer system 1210 can be of varying types including a workstation, server, computing cluster, blade server, server farm, or any other data processing system or computing device. Due to the ever-changing nature of computers and networks, the description of computer system 1210 depicted in FIG. 12 is intended only as one example. Many other configurations of computer system 1210 are possible having more or fewer components than the computer system depicted in FIG. 12.

### Particular Implementations

In one implementation, a method is described from the perspective of a server receiving messages from user software. The method includes automatically identifying shared interests between a user and respective persons in user's online social network by comparing profile information of the user and the respective persons specified in their respective social networking profiles and evaluating direct interactions on the online social network between the user and the respective persons. It also includes generating focused personas of user's social networking profile for viewing by the respective persons, including automatically prioritizing content in the user's social networking profile to be presented in the focused personas dependent on the identified shared interests.

This and other methods described can be presented from the perspective of a mobile device and user software interacting with a server. From the mobile device perspective, the method provides, relying on the server, automatically identification of shared interests between a user and respective persons in user's online social network by comparing profile information of the user and the respective persons specified in their respective social networking profiles and evaluation of direct interactions on the online social network between the user and the respective persons. It also includes generating focused personas of user's social networking profile for viewing by the respective persons, including automatically prioritizing content in the user's social networking profile to be presented in the focused personas dependent on the identified shared interests.

This method and other implementations of the technology disclosed can include one or more of the following features and/or features described in connection with additional methods disclosed. In the interest of conciseness, the combinations of features disclosed in this application are not individually enumerated and are not repeated with each base set of features. The reader will understand how features identified in this section can readily be combined with sets of base features identified as implementations such as Persona Generation Environment, User and Viewer Profiles, Interactions and Semantic Analysis, and Persona Augmentation.

The profile information includes tags that identify interests and skills of the user and the respective persons. The profile information includes tags that categorize content in the social networking profiles of the user and the respective persons.

The evaluation of the direct interactions includes focus topics identified by semantic analysis of content in the direct interactions. The semantic analysis matches the tags in the social networking profiles of the user and the respective persons.

The method further includes identifying substitutes and alternatives of the focus topics and clustering the focus topics and their respective substitutes and alternatives into topic families.

Other implementations may include a non-transitory computer readable storage medium storing instructions executable by a processor to perform any of the methods described above. Yet another implementation may include a system including memory and one or more processors operable to execute instructions, stored in the memory, to perform any of the methods described above.

In another implementation, a method is described from the perspective of a server receiving messages from user software. The method includes automatically identifying interests of respective persons in a user's online social network by evaluating profile information of the respective persons specified in their respective social networking profiles and determining influences of online social network's other objects on the respective persons. It also includes generating personalized personas of user's social networking profile for viewing by the respective persons, including automatically augmenting content in user's social networking profile from sources external to the online social network to be presented in the focused personas dependent on the identified shared interests.

This method and other implementations of the technology disclosed can include one or more of the following features and/or features described in connection with additional methods disclosed.

The sources external to the online social network include third-party applications, games, and services embedded in the online social network. External sources that should interest the respective persons are selected using profile information. The profile information includes tags that identify interests and skills of the respective persons. The profile information also includes tags that categorize content in the social networking profiles of the respective persons.

The determination of influences of the online social network's other objects on the respective persons is made dependent on at least amount of object-related content posted by a person in the online social network and number of reactions made by the person in response to posting of object-related content.

The method further includes receiving prioritization, qualification and approval from the user for content augmented in the personalized personas of user's social networking profile dependent on the identified interests of the respective persons. It also includes concurrently displaying the personalized personas and default persona of the user's social networking profile to the respective persons for comparative analysis.

Other implementations may include a non-transitory computer readable storage medium storing instructions executable by a processor to perform any of the methods described above. Yet another implementation may include a system including memory and one or more processors operable to execute instructions, stored in the memory, to perform any of the methods described above.

While the present technology is disclosed by reference to the preferred implementations and examples detailed above, it is to be understood that these examples are intended in an illustrative rather than in a limiting sense. It is contemplated that modifications and combinations will readily occur to those skilled in the art, which modifications and combinations will be within the spirit of the technology and the scope of the following claims.

1. A method, including:
automatically identifying shared interests between a user and respective persons in user's online social network by:
comparing profile information of the user and the respective persons specified in their respective social networking profiles; and
evaluating direct interactions on the online social network between the user and the respective persons; and
generating focused personas of user's social networking profile for viewing by the respective persons, including automatically prioritizing content in the user's social networking profile to be presented in the focused personas dependent on the identified shared interests.

2. The method of claim 1, wherein the profile information includes tags that identify interests and skills of the user and the respective persons.

3. The method of claim 1, wherein the profile information includes tags that categorize content in the social networking profiles of the user and the respective persons.

4. The method of claim 1, wherein the evaluation of the direct interactions includes focus topics identified by semantic analysis of content in the direct interactions, wherein the semantic analysis matches tags in the social networking profiles of the user and the respective persons.

5. The method of claim 4, further including identifying substitutes and alternatives of the focus topics and clustering the focus topics and their respective substitutes and alternatives into topic families.

6. A method, including:
automatically identifying interests of respective persons in a user's online social network by:
evaluating profile information of the respective persons specified in their respective social networking profiles;
determining influences of online social network's other objects on the respective persons; and
generating personalized personas of user's social networking profile for viewing by the respective persons, including automatically augmenting content in user's social networking profile from sources external to the online social network to be presented in the personalized personas dependent on the identified shared interests.

7. The method of claim 6, wherein the sources external to the online social network include third-party applications, games, and services embedded in the online social network that interest the respective persons.

8. The method of claim 6, wherein the profile information includes tags that identify interests and skills of the respective persons.

9. The method of claim 6, wherein the profile information includes tags that categorize content in the social networking profiles of the respective persons.

10. The method of claim 6, wherein determination of influences of the online social network's other objects on the respective persons is made dependent on at least:
amount of object-related content posted by a person in the online social network; and
number of reactions made by the person in response to postings of object-related content.

11. The method of claim 6, further including receiving prioritization, qualification, and approval from the user for content augmented in the personalized personas of user's social networking profile dependent on the identified interests of the respective persons.

12. The method of claim 6, further including concurrently displaying the personalized personas and default persona of the user's social networking profile to the respective persons for comparative analysis.

13. A system, including:
a processor and a computer readable storage medium storing computer instructions configured to cause the processor to:
automatically identify shared interests between a user and respective persons in user's online social network by:
comparing profile information of the user and the respective persons specified in their respective social networking profiles; and
evaluating direct interactions on the online social network between the user and the respective persons; and
generate focused personas of user's social networking profile for viewing by the respective persons, including automatically prioritizing content in the user's social networking profile to be presented in the focused personas dependent on the identified shared interests.

14. A system, including:
a processor and a computer readable storage medium storing computer instructions configured to cause the processor to:
automatically identify interests of respective persons in a user's online social network by:
evaluate profile information of the respective persons specified in their respective social networking profiles; and
determine influences of the respective persons on other objects in the online social network; and
generate personalized personas of user's social networking profile for viewing by the respective persons, including automatically augmenting content in user's social networking profile from sources external to the online social network to be presented in the personalized personas dependent on the identified shared interests.

15. The system of claim 14, wherein the sources external to the online social network include third-party applications, games and services embedded in the online social network that interest the respective persons.

16. The system of claim 14, wherein the profile information includes tags that identify interests and skills of the respective persons.

17. The system of claim 14, wherein the profile information includes tags that categorize content in the social networking profiles of the respective persons.

18. The system of claim 14, wherein determination of influences of the respective persons on other objects in the online social network is made dependent on at least:
amount of object-related content posted by a person in the online social network; and
number of reactions made by the person in response to posting of object-related content.

19. The system of claim 14, further configured to cause the processor to receive prioritization, qualification and approval from the user for content augmented in the personalized personas of user's social networking profile dependent on the identified interests of the respective persons.

20. The system of claim 14, further configured to cause the processor to concurrently display the personalized personas and default persona of the user's social networking profile to the respective persons for comparative analysis.
